(19) United States
(12) Patent Application Publication
(10) Pub. No.: US 2015/0026394 A1
(43) Pub. Date: Jan. 22, 2015

(54) MEMORY SYSTEM AND METHOD OF OPERATING THE SAME

(71) Applicant: SAMSUNG ELECTRONICS CO., LTD., Suwon-Si (KR)

(72) Inventors: CHAN IK PARK, SUWON-SI (KR); CHAN HA KIM, SEOUL (KR); HYUN SUN PARK, SEOUL (KR); SUNG JOO YOO, POHANG-SI (KR)

(73) Assignee: POSTECH ACADEMY-INDUSTRY FOUNDATION, POHANG-SI (KR)

(21) Appl. No.: 14/326,276

(22) Filed: Jul. 8, 2014

(30) Foreign Application Priority Data
Jul. 18, 2013 (KR) 10-2013-0084748

(51) Int. Cl. G06F 12/08; G06F 12/02

(52) U.S. Cl. CPC G06F 12/0873; G06F 12/0246; G06F 12/0253; G06F 2212/702
USPC 711/103

(57) ABSTRACT

A method of operating a memory system includes the operations of outputting dirty cache lines from a data cache to a volatile memory device as instructions are executed, and outputting from the volatile memory device to a non-volatile memory device as many dirty cache lines as the size of a page of the non-volatile memory.

### CROSS-REFERENCE TO RELATED APPLICATIONS

This application claims priority under 35 U.S.C. §119(a) from Korean Patent Application No. 10-2013-0084748 filed on Jul. 18, 2013, the disclosure of which is hereby incorporated by reference in its entirety.

### BACKGROUND

Example embodiments relate to a memory system, and more particularly, to a memory system including a non-volatile memory device having an increased lifespan and a method of operating the memory system.

Memory systems may include a central processing unit (CPU) and a plurality of memory devices. For example, each of the memory devices may be a volatile memory device such as, for example, a dynamic random access memory (DRAM), or a non-volatile memory device such as, for example, a flash memory.

The CPU and one of the memory devices may exchange data with each other. The memory devices may exchange data with each other. When data transmission frequently occurs between components of the memory system, power consumption of the memory system may increase.

In addition, some non-volatile memory devices such as flash memory devices have a limited number of program-erase cycles (generally, referred to as P/E cycles). Thus, there is a demand for a memory system which exhibits decreased power consumption. There is also a demand for a memory system which can improve the lifespan of a non-volatile memory device included in the memory system. There is additionally a demand for a method for decreasing power consumption of a memory system. There is further a demand for a method of improving the lifespan of a non-volatile memory device included in the memory system.

### SUMMARY

The inventive concept provides a memory system capable of reducing power consumption and including a non-volatile memory device having an increased lifespan, and a method of operating the memory system.

According to an aspect of the inventive concept, there is provided a method of operating a memory system. The method includes outputting dirty cache lines from a data cache to a volatile memory device as instructions are executed, and outputting from the volatile memory device to a non-volatile memory device as many dirty cache lines as the size of a page of a non-volatile memory device from the volatile memory device.

In some embodiments, the method may further include moving the dirty cache lines stored in different regions of the volatile memory device to an arbitrary region of the volatile memory device.

In some embodiments, the arbitrary region of the volatile memory device is allocated the same size as the page of the non-volatile memory device.

In some embodiments, when the arbitrary region of the volatile memory device is full of dirty cache lines, as many dirty cache lines as the size of the page of the non-volatile memory device are output from the volatile memory device to the non-volatile memory.

According to some embodiments, the method may further include mapping logical addresses of dirty cache lines stored in the non-volatile memory device to physical addresses of the cache lines in the non-volatile memory device.

According to some embodiments, the method may further include performing a garbage collection operation on the non-volatile memory device by directly using at least one of the dirty cache lines stored in the volatile memory device.

According to another aspect of the inventive concept, there is provided a memory system. The memory system includes including a central processing unit (CPU) that includes an instruction cache including instructions and a data cache including cache lines, a volatile memory device that stores dirty cache lines from among the cache lines of the data cache as the instructions are executed, and which collects the dirty cache lines, a non-volatile memory device, and a memory controller block that controls the volatile memory device to transmit the collected dirty cache lines corresponding to the size of a page of the non-volatile memory device to the non-volatile memory device.

In some embodiments, the volatile memory device stores a bitmap that represents where the dirty cache lines are stored in the volatile memory device.

In some embodiments, the volatile memory device includes a memory buffer in which the collected dirty cache lines are stored.

According to some embodiments, the memory controller block stores a bitmap that represents where the dirty cache lines are stored in the volatile memory device.

According to some embodiments, the memory controller block includes a memory buffer in which the collected dirty cache lines are stored.

In some embodiments, the memory controller block stores a mapping table mapping which maps logical addresses of dirty cache lines stored in the non-volatile memory device to physical addresses of the dirty cache lines stored in the non-volatile memory device.

According to some embodiments, the memory controller block may control the non-volatile memory device to perform a garbage collection operation by directly using at least one of the dirty cache lines collected in the volatile memory device.

In some embodiments, the dirty cache lines are written to one page of the non-volatile memory device. In some embodiments, the memory system is included in a portable device.

According to an aspect of the inventive concept, there is provided a memory system comprising: processor having associated therewith a data cache having cache lines stored therein; a non-volatile memory device which is configured to store data therein, wherein the non-volatile memory device performs read operations and write operations for the data in a unit of a page; a volatile memory device having a first memory region configured to store dirty cache lines from among the cache lines of the data cache which are output from the data cache as the processor executes instructions, and having a second memory region having a size at least equal to a size of one page of the non-volatile memory device, wherein the dirty cache lines stored in the first memory region are subsequently collected in the second memory region; and a memory control system configured to control the volatile memory device such that when a number of the collected dirty cache lines in the second memory region is equal to at least the size of one page of the non-volatile memory device, the volatile memory device transmits to the non-volatile memory device a plurality of the collected dirty cache lines in a unit corresponding to the size of the page of the non-volatile memory device.

In some embodiments, the memory system further includes a stored bitmap identifying locations of the dirty cache lines in the first memory region of the volatile memory device.

In some embodiments, the memory control system stores a mapping table that maps logical addresses of dirty cache lines stored in the non-volatile memory device to physical addresses of the dirty cache lines in the non-volatile memory device.

In some embodiments, the memory control system controls the non-volatile memory device to perform a garbage collection operation by copying at least one of the dirty cache lines collected in the volatile memory device to the non-volatile memory device.

In some embodiments, the memory control system includes at least one buffer, and the volatile memory device is configured to transmit the plurality of the collected dirty cache lines to the non-volatile memory device via the at least one buffer.

### BRIEF DESCRIPTION OF THE DRAWINGS

These and/or other aspects and advantages of the present inventive concepts will become apparent and more readily appreciated from the following description of the embodiments, taken in conjunction with the accompanying drawings of which:

FIG. 1 is a block diagram of a memory system according to an embodiment of the inventive concept.

FIG. 2 is a block diagram of an application processor and first and second memory devices included in the memory system illustrated in FIG. 1.

FIG. 3 is a diagram for describing a collection operation of the first memory device illustrated in FIG. 1.

FIG. 4 is a diagram for describing a mapping operation of the second memory device illustrated in FIG. 2.

FIG. 5 is a diagram for describing a garbage collection operation of the second memory device illustrated in FIG. 2.

FIG. 6 is a flowchart of an operation of a memory system, according to an embodiment of the inventive concept.

### DETAILED DESCRIPTION OF THE EMBODIMENTS

The present inventive concepts now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein

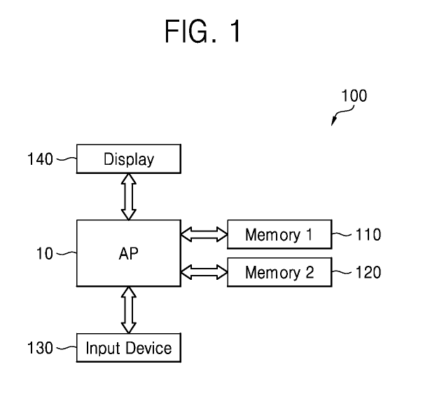

FIG. 1 is a block diagram of a memory system 100 according to an embodiment of the inventive concept. Referring to FIG. 1, the memory system 100 may be implemented by using a portable device, such as a laptop computer, a cellular phone, a smart phone, a tablet PC, a personal digital assistant (PDA), an enterprise digital assistant (EDA), a digital still camera, a digital video camera, a portable multimedia player (PMP), a personal navigation device or a portable navigation device (PDN), a handheld game console, a wearable computer, or an e-book.

The memory system 100 may include an application processor (AP) 10, a plurality of memory devices, namely, a first memory device 110 and a second memory device 120, an input device 130, and a display 140.

AP 10 controls an operation of memory system 100. For example, AP 10 may execute program instructions (for example, program instructions generated by an input signal that is received via the input device 130), may read data from one of first and second memory devices 110 and 120, and may display the read data via display 140. According to an embodiment, AP 10 may be referred to as a processor or a system on chip (SOC).

First memory device 110 may be implemented by using a volatile memory device, for example, a dynamic random access memory (DRAM), a static random access memory (SRAM), a rambus DRAM (RDRAM), a thyristor RAM (T-RAM), a zero capacitor RAM (Z-RAM), or a twin transistor RAM (TTRAM).

Second memory device 120 may be implemented by using a non-volatile memory device, for example, an electrically erasable programmable read-only memory (EEPROM), a flash memory, a magnetic RAM (MRAM), a spin transfer torque MRAM (STT-MRAM), a conductive bridging RAM (CBRAM), a ferroelectric RAM (FeRAM), a Phase change RAM (PRAM), a resistive RAM (RRAM), a nanotube RRAM (NRRAM), a polymer RAM (PoRAM), a nano floating gate memory (NFGM), a holographic memory, a molecular electronics memory device, or an insulator resistance change memory.

Input device 130 may be implemented by using a touch pad. According to an embodiment, memory system 100 may implemented by using a personal computer (PC).

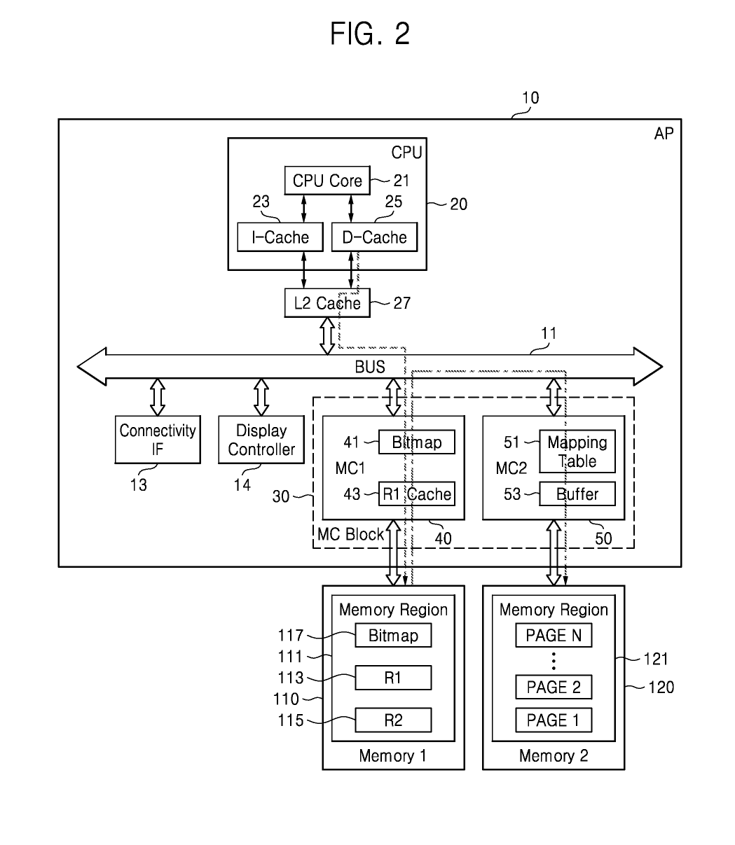

FIG. 2 is a block diagram of application processor 10 and first and second memory devices 110 and 120 illustrated in FIG. 1. Referring to FIGS. 1 and 2, AP 10 includes a connectivity interface (IF) 13, a display controller 14, a central processing unit (CPU) 20, an L2 cache 27, and a memory control system or memory controller block 30.

Each of the components 13, 14, 27, and 30 of the AP 10 may exchange data or a command with each other via a bus 11. Connectivity IF 13 may be used when input device 130 communicates with other components (for example, CPU 20) of the AP 10. Display controller 14 controls display 140 to display image data.

CPU 20 may be a part of the AP 10 capable of reading and executing program instructions. CPU 20 may include a CPU core 21 and a plurality of caches, namely, caches 23 and 25. CPU core 21 is a unit capable of executing program instructions. According to an embodiment, CPU 20 may include a plurality of CPU cores.

Cache 23 may be referred to as an instruction cache, and cache 25 may be referred to as a data cache. Instruction cache 23 is used to speed up executable instruction fetch by CPU core 21. Instruction cache 23 can store the program instructions executed in CPU 20.

Data cache 25 is used to speed data fetch and storage. Data cache 25 is divided into a plurality of chunks. The chunks are referred to as cache lines. Each cache line may have one of three states. According to the three states, a cache line may be referred to as an invalid cache line, a clean cache line, or a dirty cache line. The invalid cache line denotes that a cache line does not include valid data. The clean cache line denotes that a cache line is only used in a read memory operation and that the data stored in the cache line is not modified. The dirty cache line denotes that a cache line is used in a write and/or read memory operation, and that the data stored in the cache line is modified.

As instructions stored in instruction cache 23 are executed by CPU 21, dirty cache lines of data cache 25 may be sequentially output to first memory device 110.

Instruction cache 23 and data cache 25 may be implemented by using volatile memories (for example, SRAMs). According to an embodiment, AP 10 may include multi-level caches. For example, when instruction cache 23 and data cache 25 are level-1 caches, then L2 cache 27 may be a level-2 cache. L2 cache 27 may be implemented by using a volatile memory device (for example, a SRAM). Although FIG. 2 illustrates that L2 cache 27 is located outside CPU 20, in some embodiments L2 cache 27 may be located inside CPU 20.

Memory controller block 30 controls operations of first and second memory devices 110 and 120. Memory controller block 30 includes a first memory controller 40 for controlling an operation of first memory device 110, and a second memory controller 50 for controlling an operation of second memory device 120. According to an embodiment, memory controller block 30 may be implemented by using one circuit in order to control operations of first and second memory devices 110 and 120.

First memory device 110 includes a memory region 111 for storing data. Memory region 111 may include a first memory region 113, a second memory region 115, and a bitmap 117.

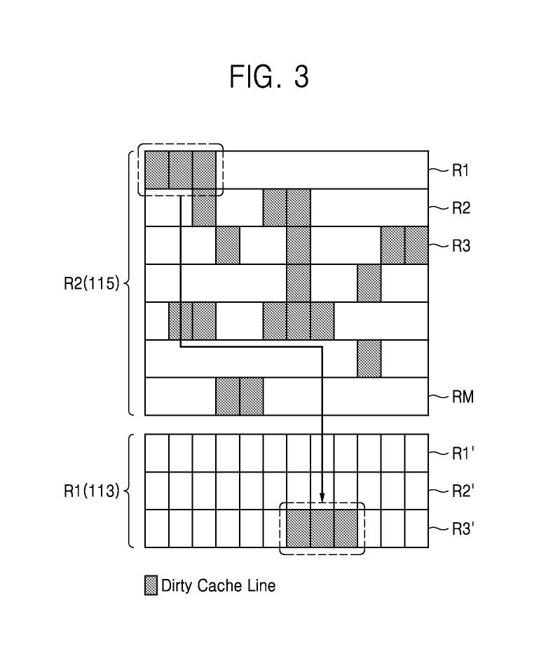

FIG. 3 is a diagram for describing a collection operation of the first memory device 110 illustrated in FIG. 1. Referring to FIGS. 1 through 3, first memory region 113 and second memory region 115 may be divided into a plurality of rows R1′ through R3′ and R1 through RM (where M is a natural), respectively. According to an embodiment, the numbers of rows of the first memory region 113 and the second memory region 115 may vary. The dirty cache lines output by the data cache 25 are stored in a scattered manner throughput second memory region 115.

Bitmap 117 represents portions of the second memory region 115 where the dirty cache lines are stored. Bitmap 117 is stored in the memory region 111 of the first memory device 110. According to an embodiment, first memory controller 40 may include a memory device (e.g., RAM) storing a bitmap 41 corresponding to bitmap 117. According to an embodiment, first memory device 110 does not include bitmap 117, but first memory controller 40 may include the bitmap 41.

The dirty cache lines stored in a scattered manner throughout second memory region 115 may be collected in first memory region 113. In other words, the dirty cache lines which are stored in a scattered manner throughout the second memory region 115 may be moved to the first memory region 113. First memory region 113 may be referred to as a memory buffer. In some embodiments, first memory region 113 may be allocated to have the same size as a page of second memory device 120. In some embodiments, first memory region 113 may be allocated to be larger than the size of a page of second memory device 120.

First memory controller 40 may include a first region cache 43 that stores some of the dirty cache lines stored in first memory region 113. In some embodiments, when the number of the collected dirty cache lines in first memory region 113 is at equal to (or in some embodiments greater than) the size of one page of the non-volatile memory device (e.g., when the first memory region 113 is full of the dirty cache lines), memory controller block 30 controls first memory device 110 to transmit to the second memory device 120 as many collected dirty cache lines as the size of a page of the second memory device 120.

Referring to FIG. 2, second memory device 120 includes a memory region 121. Memory region 121 may be divided into a plurality of pages PAGE1 through PAGEN (where N is a natural number). In second memory device 120, a read operation or a write operation is performed in units of pages.

Second memory controller 50 includes a mapping table 51 that maps a logical address with a physical address in units of cache lines, and a buffer 53 that temporarily stores dirty cache lines output by first memory device 110. According to an embodiment, mapping table 51 or buffer 53 may be loaded to second memory controller 50 after being stored in second memory device 120.

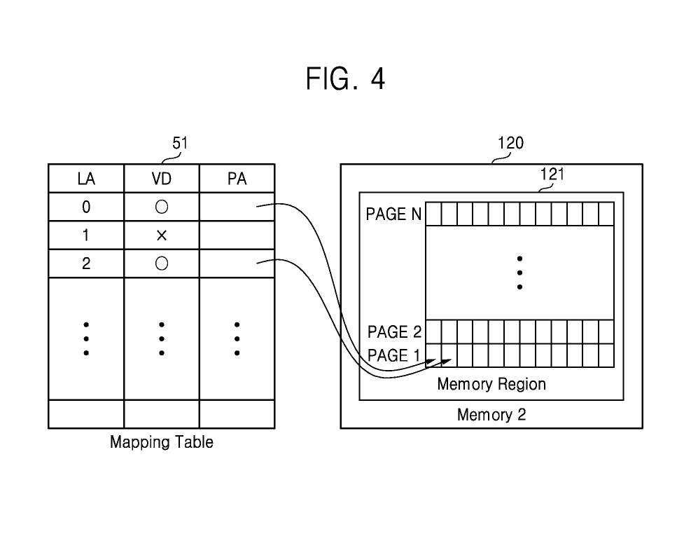

FIG. 4 is a diagram for describing a mapping operation of second memory device 120 illustrated in FIG. 2. Referring to FIGS. 1, 2, and 4, mapping table 51 includes logical addresses (LAs) of dirty cache lines, validities (VDs) of the dirty cache lines, and physical addresses (PAs) of the dirty cache lines.

When dirty cache lines are transmitted from first memory device 110 to second memory device 120, the transmitted dirty cache lines may have LAs. In other words, each of the dirty cache lines may have a LA. The LAs of dirty cache lines must be transformed to PAs in order to store the dirty cache lines in the pages of second memory device 120

In the VDs of dirty cache lines, ‘O’ represents that a dirty cache line is valid, and ‘X’ represents that a dirty cache line is not valid. For example, in FIG. 4, a dirty cache line having an LA of ‘0’ is valid, a dirty cache line having an LA of ‘1’ is not valid, and a dirty cache line having an LA of ‘2’ is valid.

In second memory device 120, each of the pages PAGE1 through PAGEN may be divided into the same units (hereinafter, referred to as cache lines) as cache lines.

The dirty cache line having an LA of ‘0’ is stored in a first cache line of the first page PAGE1 according to mapping table 51. The dirty cache line having an LA of ‘2’ is stored in a second cache line of the first page PAGE1 according to mapping table 51. Since dirty cache lines are sequentially stored in a page of second memory device 120, the number of times a write operation is performed on second memory device 120 may be decreased.

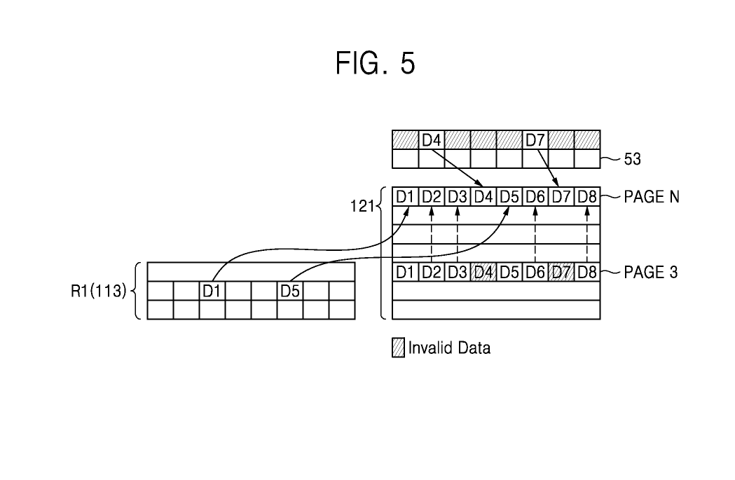

FIG. 5 is a diagram for describing a garbage collection operation of second memory device 120 illustrated in FIG. 2. Referring to FIGS. 1, 2, and 5, the garbage collection operation is performed on second memory device 120 by directly using at least one of the dirty cache lines collected in first memory device 110 (e.g., collected in first memory region 113 of first memory device 110). The garbage collection operation denotes an operation in which garbage is periodically collected to reclaim the storage capacity of a non-volatile memory device.

In order to erase the page PAGE3 of second memory device 120, valid data D2, D3, D6, and D8 stored in the page PAGE3 are copied into the page PAGEN. The valid data are in the same units as cache lines. Buffer 53 included in second memory controller 50 includes valid data D4 and valid data D7. The valid data D4 and the valid data D7 are copied into the page PAGEN. Valid data D1 and valid data D5 stored in first memory region 113 are directly copied into the page PAGEN.

Due to the direct copying of the valid data D1 and the valid data D5 stored in first memory region 113 into the page PAGEN, second memory device 120 may avoid an additional write operation.

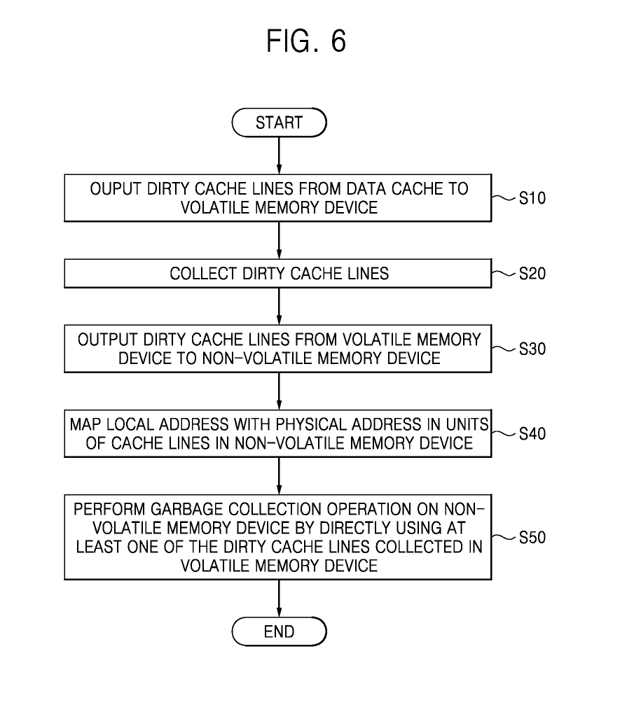

FIG. 6 is a flowchart of an operation of memory system 100, according to an embodiment of the inventive concept. Referring to FIGS. 1 through 6, dirty cache lines are output from data cache 25 to first memory device 110 as instructions are executed by CPU core 21, in operation S10. First memory device 110 is a volatile memory device like a DRAM.

Memory controller block 30 controls first memory device 110 to collect dirty cache lines, in operation S20. The dirty cache lines which are stored in a scattered manner throughout second memory region 115 of first memory device 110 are moved to first memory region 113. First memory region 113 may have the same size as a page of second memory device 120.

Memory controller block 30 controls first memory device 110 to output the dirty cache lines to second memory device 120, in operation S30. Second memory device 120 is a non-volatile memory device such as a flash memory. When first memory region 113 of first memory device 110 is full of dirty cache lines, the dirty cache lines may be output from first memory device 110 to second memory device 120.

Mapping table 51 includes PAs corresponding to LAs in units of cache lines. In operation S40, the dirty cache lines are sequentially stored in a page (for example, the page PAGE1) of second memory device 120 by using the PAs mapped with the LAs of the dirty cache lines in mapping table 51.

In operation S50, a garbage collection operation may be performed on second memory device 120 by directly using at least one of the dirty cache lines collected in first memory device 110.

In a memory system and a method of operating the memory system according to an embodiment of the inventive concept, a volatile memory device included in the memory system outputs as many dirty cache lines as the size of a page of a non-volatile memory device included in the memory system to the non-volatile memory device, thereby decreasing power consumption of the memory system and improving the lifespan of the non-volatile memory device.

While the inventive concept has been particularly shown and described with reference to exemplary embodiments thereof, it will be understood that various changes in form and details may be made therein without departing from the spirit and scope of the following claims.

What is claimed is:

1. A method of operating a memory system, the method comprising:
outputting dirty cache lines from a data cache to a volatile memory device as instructions are executed; and
outputting from the volatile memory device to a non-volatile memory device as many dirty cache lines as a size of a page of the non-volatile memory device.

2. The method of claim 1, further comprising moving the dirty cache lines stored in different regions of the volatile memory device to an arbitrary region of the volatile memory device.

3. The method of claim 2, wherein the arbitrary region of the volatile memory device is allocated the same size as the page of the non-volatile memory device.

4. The method of claim 2, wherein, when the arbitrary region of the volatile memory device is full of dirty cache lines, as many dirty cache lines as the size of the page of the non-volatile memory device are output from the volatile memory device to the non-volatile memory.

5. The method of claim 1, further comprising mapping logical addresses of dirty cache lines stored in the non-volatile memory device to physical addresses of the dirty cache lines stored in the non-volatile memory device.

6. The method of claim 2, further comprising performing a garbage collection operation on the non-volatile memory device by directly using at least one of the dirty cache lines stored in the volatile memory device.

7. A memory system, comprising:
a central processing unit (CPU) that includes an instruction cache including instructions and a data cache including cache lines;
a volatile memory device that stores dirty cache lines from among the cache lines of the data cache as the instructions are executed, and which collects the dirty cache lines;
a non-volatile memory device; and
a memory controller block that controls the volatile memory device to transmit the collected dirty cache lines corresponding to the size of a page of the non-volatile memory device to the non-volatile memory device.

8. The memory system of claim 7, wherein the volatile memory device stores a bitmap that represents where the dirty cache lines are stored in the volatile memory device.

9. The memory system of claim 7, wherein the volatile memory device comprised a memory buffer in which the collected dirty cache lines are stored.

10. The memory system of claim 7, wherein the memory controller block stores a bitmap that represents where the dirty cache lines are stored in the volatile memory device.

11. The memory system of claim 7, wherein the memory controller block comprises a memory buffer in which the collected dirty cache lines are stored.

12. The memory system of claim 7, wherein the memory controller block stores a mapping table which maps logical addresses of dirty cache lines stored in the non-volatile memory device to physical addresses of the dirty cache lines stored in the non-volatile memory device.

13. The memory system of claim 7, wherein the memory controller block controls the non-volatile memory device to perform a garbage collection operation by directly using at least one of the dirty cache lines collected in the volatile memory device.

14. The memory system of claim 7, wherein the dirty cache lines are written to one page of the non-volatile memory device.

15. The memory system of claim 7, wherein the memory system is a portable device.

16. A memory system, comprising:
a processor having associated therewith a data cache having cache lines stored therein;
a non-volatile memory device which is configured to store data therein, wherein the non-volatile memory device performs read operations and write operations for the data in a unit of a page;
a volatile memory device having a first memory region configured to store dirty cache lines from among the cache lines of the data cache which are output from the data cache as the processor executes instructions, and having a second memory region having a size at least equal to a size of one page of the non-volatile memory device, wherein the dirty cache lines stored in the first memory region are subsequently collected in the second memory region; and
a memory control system configured to control the volatile memory device such that when a number of the collected dirty cache lines in the second memory region is equal to at least the size of one page of the non-volatile memory device, the volatile memory device transmits to the non-volatile memory device a plurality of the collected dirty cache lines in a unit corresponding to the size of the page of the non-volatile memory device.

17. The memory system of claim 16, further including a stored bitmap identifying locations of the dirty cache lines in the first memory region of the volatile memory device.

18. The memory system of claim 16, wherein the memory control system stores a mapping table that maps logical addresses of dirty cache lines stored in the non-volatile memory device to physical addresses of the dirty cache lines in the non-volatile memory device.

19. The memory system of claim 16, wherein the memory control system controls the non-volatile memory device to perform a garbage collection operation by copying at least one of the dirty cache lines collected in the volatile memory device to the non-volatile memory device.

20. The memory system of claim 16, wherein the memory control system includes at least one buffer, and wherein the volatile memory device is configured to transmit the plurality of the collected dirty cache lines to the non-volatile memory device via the at least one buffer.
